(19) United States
(12) Patent Application Publication
(10) Pub. No.: US 2025/0238003 A1
(43) Pub. Date: Jul. 24, 2025

(54) INTELLIGENT ASSISTANT AND METHOD FOR CONTROLLING SAME

(71) Applicant: SAMSUNG ELECTRONICS CO., LTD., Suwon-si (KR)

(72) Inventors: Seunghwan CHOI, Suwon-si (KR); Yoonsu KIM, Suwon-si (KR); Hyunjin KIM, Suwon-si (KR); Haeyoon PARK, Suwon-si (KR)

(21) Appl. No.: 19/172,594

(22) Filed: Apr. 7, 2025

Related U.S. Application Data
(63) Continuation of application No. PCT/KR2023/012314, filed on Aug. 21, 2023.

(30) Foreign Application Priority Data
Oct. 18, 2022 (KR) 10-2022-0134234

(51) Int. Cl. G05B 13/02

(52) U.S. Cl. CPC G05B 13/0265

(57) ABSTRACT

The present disclosure relates to an intelligent assistant and a method for controlling same. A method according to one embodiment comprises: an operation of determining an execution function to be performed by a user device and a type of automation process for performing the execution function, on the basis of automation reference information; an operation of transmitting at least one of a control command and a function suggestion message to one or more user devices on the basis of the type of the automation process; and an operation of receiving a response to at least one of the control command and the function suggestion message, and updating the automation reference information on the basis of attributes of the received response.

### CROSS-REFERENCE TO RELATED APPLICATIONS

This application claims priority to Korean Patent Application No. 10-2022-0134234, filed on Oct. 18, 2022, and PCT Patent Application No. PCT/KR2023/012314, filed on Aug. 21, 2023, and all the benefits accruing therefrom under 35 U.S.C. § 119, the contents of which in their entirety are herein incorporated by reference.

### BACKGROUND

### Field

The disclosure relates to an intelligent assistant and a method for controlling the same.

### Description of the Related Art

The Internet of Things (IoT) refers to technology for accessing the Internet by equipping various things with computer chips and communication features. An IoT device may be a general device (or thing) to which the IoT is applied. For example, IoT devices may include various sensors, such as temperature sensors, humidity sensors, sound sensors, motion sensors, proximity sensors, gas detection sensors, and heat detection sensors, various home appliances, such as refrigerators, CCTVs, TVs, washers, and dehumidifiers, lights, fire alarms, and home devices.

Users may remotely control IoT devices using their own wireless devices. For example, a user may operate a washer or a vacuum in her home by controlling a wireless device even when she is at work.

### SUMMARY

The disclosure proposes a service for recommending an execution function expected to be used by the user or controlling it to be performed immediately based on various device use histories of the user. The disclosure also provides an intelligent assistant, an electronic device, and a method for controlling the same, to provide such a service.

According to an embodiment, a method for controlling a user device by an intelligent assistant may comprise determining an execution function to be performed by the user device and a type of an automation process for performing the execution function based on automation reference information, transmitting at least one of a control command and a function suggestion message to at least one user device based on the type of the automation process, and receiving a response to at least one of the control command and the function suggestion message and updating the automation reference information based on an attribute of the received response. Further, responsive to the type of the automation process being determined as a first type, the control command may be defined as a first control command, and the first control command may include one or more instructions controlling the user device to execute the execution function. Further, responsive to the type of the automation process being determined as a second type, the control command may be defined as a second control command, and the second control command may include one or more instructions controlling the user device to execute the execution function in response to an elapse of a predefined time. Further, responsive to the type of the automation process being determined as a third type, the control command may be defined as a third control command, and the third control command may include one or more instructions controlling the user device to execute the execution function in response to a user input.

In an embodiment, the method may comprise transmitting a guide message to a remote control device connected to the user device through a network based on the type of the automation process being determined as the first type. The guide message may include text information associated with execution of the execution function.

In an embodiment, the method may comprise activating a first feedback window for a predefined time based on the type of the automation process being determined as the first type, and decreasing a feedback value constituting the automation reference information based on a negative response being received from the user device while the first feedback window is activated.

In an embodiment, the method may comprise transmitting a function suggestion message of the first type together with the second control command to at least one of the user device and a remote control device based on the type of the automation process being determined as the second type. Further, the function suggestion message of the first type may include text information predicting execution of the execution function.

In an embodiment, the method may comprise activating a second feedback window for a predefined time based on the type of the automation process being determined as the second type, and while the second feedback window is activated, increasing a feedback value constituting the automation reference information based on receiving a positive response from any one of the user device and the remote control device, decreasing the feedback value constituting the automation reference information based on receiving a negative response from any one of the user device and the remote control device, and maintaining the feedback value constituting the automation reference information based on receiving a neutral response from any one of the user device and the remote control device.

In an embodiment, the method may comprise transmitting the first control command to enable the user device to perform the execution function based on receiving the positive response from the remote control device.

In an embodiment, the method may comprise transmitting a function suggestion message of the second type together with the third control command to at least one of the user device and a remote control device based on the type of the automation process being determined as the third type. Further, the function suggestion message of the second type may include a query for execution of the execution function.

In an embodiment, the method may comprise activating a third feedback window for a predefined time based on the type of the automation process being determined as the third type, and while the third feedback window is activated, increasing a feedback value constituting the automation reference information based on receiving a positive response from any one of the user device and the remote control device, and decreasing the feedback value constituting the automation reference information based on receiving a negative response from any one of the user device and the remote control device.

In an embodiment, the method may comprise transmitting the first control command to enable the user device to perform the execution function based on receiving the positive response from the remote control device.

In an embodiment, the third control command may include one or more instructions controlling the user device to output text information constituting the second type of function suggestion message as a voice.

In an embodiment, the method may comprise determining a speech pattern of the voice output based on the automation reference information. Further, the speech pattern may include at least one of a frequency, a pitch, an utterance time, an utterance speed, an inter-phrase time width, or an inter-word time width.

In an embodiment, as a recommendation degree of the automation reference information decreases, at least one of the inter-phrase time width or the inter-word time width may increase.

In an embodiment, as a recommendation degree of the automation reference information increases, the speech pattern may be composed of a downward intonation.

In an embodiment, as a recommendation degree of the automation reference information decreases, the speech pattern may be composed of an upward intonation.

In an embodiment, an intelligent assistant may include one or more memories, one or more transceivers, and one or more processors electrically connected to the one or more memories and the one or more transceivers. The one or more processors may support: determining an execution function to be performed by a user device and a type of an automation process for performing the execution function based on automation reference information, transmitting at least one of a control command and a function suggestion message to at least one user device based on the type of the automation process, and receiving a response to at least one of the control command and the function suggestion message and updating the automation reference information based on an attribute of the received response. Further, responsive to the type of the automation process being determined as a first type, the control command may be defined as a first control command, and the first control command may include one or more instructions controlling the user device to execute the execution function. Further, responsive to the type of the automation process being determined as a second type, the control command may be defined as a second control command, and the second control command may include one or more instructions controlling the user device to execute the execution function in response to an elapse of a predefined time. Further, responsive to the type of the automation process being determined as a third type, the control command may be defined as a third control command, and the third control command may include one or more instructions controlling the user device to execute the execution function in response to a user input.

According to various embodiments of the disclosure, the intelligent assistant may control to immediately execute a specific function according to automation reference information, control to wait and then execute it, or inquire whether to execute it. In other words, the intelligent assistant according to an embodiment may automatically propose the user for user-adaptive function execution by inferring the user's intention in advance.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

FIG. 1 is a view schematically illustrating an automation system of the disclosure according to one or more embodiments;

FIG. 2 illustrates an example of an electronic device applied to the automation system of FIG. 1 according to one or more embodiments;

FIG. 3 is a concept view illustrating a structure of operation information according to one or more embodiments;

FIGS. 4 and 5 are concept views illustrating an example of a structure of automation reference information according to one or more embodiments;

FIG. 6 is a concept view exemplarily illustrating a type of an automation process according to one or more embodiments;

FIG. 7 is a reference view illustrating a process of performing a primary execution function based on a recommendation degree according to one or more embodiments;

FIG. 8 is a reference view illustrating a process of performing a secondary execution function based on a recommendation degree according to one or more embodiments;

FIG. 9 illustrates an example of performing an execution function based on a first type of automation process applied to an embodiment according to one or more embodiments;

FIG. 10 illustrates an example of performing an execution function based on a second type of automation process applied to an embodiment according to one or more embodiments;

FIG. 11 illustrates an example of performing an execution function based on a third type of automation process applied to an embodiment according to one or more embodiments;

FIG. 12 illustrates an example of performing an execution function based on a first type of automation process applied to an embodiment according to one or more embodiments;

FIG. 13 illustrates an example of performing an execution function based on a second type of automation process applied to an embodiment according to one or more embodiments;

FIG. 14 illustrates an example of performing an execution function based on a third type of automation process applied to an embodiment according to one or more embodiments;

FIG. 15 is a flowchart illustrating a control method according to an embodiment according to one or more embodiments;

FIG. 16 is a flowchart illustrating a control method according to an embodiment according to one or more embodiments; and

FIGS. 17 to 20 are flowcharts illustrating a control method according to an embodiment according to one or more embodiments.

Reference may be made to the accompanying drawings in the following description, and specific examples that may be practiced are shown as examples within the drawings. Other examples may be utilized and structural changes may be made without departing from the scope of the various examples.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

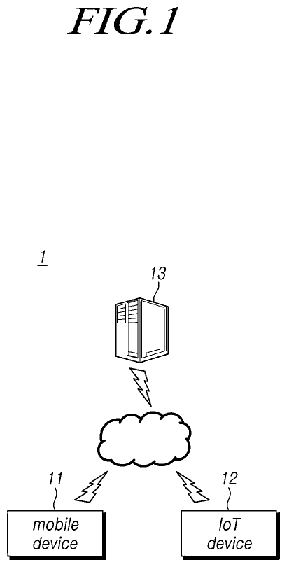

FIG. 1 is a view schematically illustrating an automation system of the disclosure.

The automation system 1 includes a mobile device 11, a base station (not shown), and a network. The mobile device 11 means an electronic device that performs communication by radio access technology (e.g., 5G new radio (NR) or long-term evolution (LTE)), and may be referred to as a communication/mobile device 11. Although not limited thereto, the mobile device 11 may include a robot, a vehicle, an extended reality (XR) device, a portable device, a home appliance, an Internet of Things (IoT) device 12, and an artificial intelligence (AI) device.

The mobile device 11 may be connected to the network through the base station. The mobile device 11 may adopt AI technology and may be connected to an AI service server capable of providing AI services through the network.

The network may be configured as a 3G/4G/5G/6G network or the like. Mobile devices 11 may communicate with each other via the base station or network or directly (e.g., sidelink communication) without passing through the base station or network.

In an embodiment of the disclosure, the AI service server 13 may include an IoT service server. More specifically, the IoT service server may include a content recommendation server for recommending media content to the mobile device 11, a text-to-speech (TTS) server for analyzing user utterance, and a speech-to-text (STT) server for synthesizing text into voice. Further, the AI service server 13 may include a natural language processing (NLP) server or a natural language understanding (NLU) server for identifying the user's intent from the user utterance.

In the disclosure, the mobile device 11 may be referred to as a first user device 11, and the IoT device 12 may be referred to as a second user device 12. Further, the AI service server 13 may include an intelligent assistant or may be referred to as an intelligent assistant 13. The respective functions and roles are described below.

The automation system of the disclosure may include an intelligent assistant 13, a first user device 11, and a second user device 12. In an embodiment, the intelligent assistant 13 may be provided as a component of at least one of the first user device 11 or the second user device 12. Further, in an embodiment, the intelligent assistant 13 may be a separate user device independent of the first and second user devices 11 and 12. The intelligent assistant 13 may be provided, e.g., in the form of a server, but is not limited thereto.

The intelligent assistant 13 of the disclosure may be implemented as various user devices. The intelligent assistant 13 device may be implemented as, e.g., an IoT device, a sensor device, a hub device, a home appliance device, a wireless terminal (e.g., a smartphone, a tablet, a smart glass, or a smart watch), a desktop computing device, or a laptop computing device, but is not limited thereto.

The intelligent assistant 13 of the disclosure may wirelessly control at least one of the first user device 11 and/or the second user device 12. For example, the intelligent assistant 13 may transmit a control command to the first user device 11 and/or the second user device 12, thereby enabling the first user device 11 and/or the second user device 12 to perform an operation corresponding to the control command. The intelligent assistant 13 may transmit a control command directly to the first user device 11 and/or the second user device 12 or transmit the control command to the second server through a network including a separately provided server (e.g., a service server).

The first user device 11 of the disclosure may wirelessly transmit/receive information, data, signals, or messages with the intelligent assistant 13. The second user device 12 of the disclosure may wirelessly transmit/receive information, data, signals, or messages with the intelligent assistant 13. The first user device 11 of the disclosure may transmit/receive information, data, signals, or messages with the second user device 12.

The intelligent assistant 13, the first user device 11, and the second user device 12 of the disclosure may include one or more memories, one or more transceivers, and one or more processors.

One or more memories and one or more transceivers may be electrically connected to one or more processors. The memory, transceiver, and/or processor may each be comprised of an individual electronic component or may be comprised of a single electronic component. The memory, transceiver, and/or processor may each include a control circuit unit to perform its respective role.

In the disclosure, the memory, transceiver and processor may include a memory circuit unit, a transceiver circuit unit and a processing circuit unit for performing their respective roles. The memory, processor, and transceiver are described below with reference to the block diagrams below.

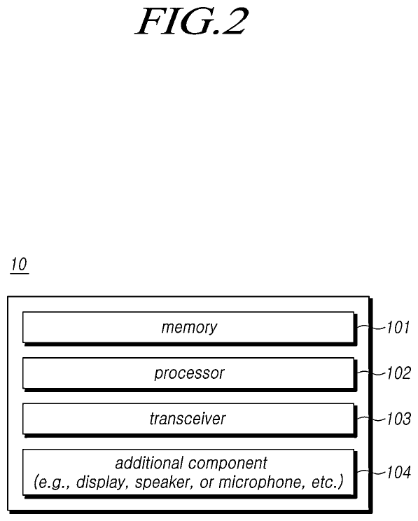

FIG. 2 is a block diagram illustrating an electronic device applied to the automation system of FIG. 1.

In the disclosure, the intelligent assistant, the first user device and the second user device may each be composed of an electronic device. The electronic device may include a controller, a memory and a communication unit, as described below.

The electronic device 10 according to various embodiments of the disclosure may include a processor 102, a memory 101, and a transceiver 103. The memory 101 and the transceiver 103 may be electrically or functionally connected to the processor 102. The processor 102 may control components constituting the electronic device 10 by generating and transmitting a control command.

According to various embodiments of the disclosure, the processor 102 may include a storage and processing circuit unit for supporting the operation of the electronic device 10. The storage and processing circuit unit may include storage, such as non-volatile memory 101 (e.g., flash memory, or other electrically programmable read only memory (ROM) configured to form a solid state drive (SSD)) or volatile memory (e.g., static or dynamic random access memory (RAM)). The processing circuit unit in the processor 102 may be used to control the operation of the electronic device 10. The processing circuit unit may be based on one or more microprocessor(s), microcontroller(s), digital signal processor(s), baseband processor(s), power management section(s), audio chip(s), or application specific integrated circuit(s).

According to various embodiments of the disclosure, the memory 101 may include a memory area for one or more processors 102 for storing variables used in the protocol, configuration, control, and other functions of the electronic device 10, including operations corresponding to or including any one of the methods and/or procedures described as an example in the disclosure. Further, the memory 101 may include non-volatile memory, volatile memory, or a combination thereof. Further, the memory 101 may interface with a memory slot that enables insertion and removal of removable memory cards in one or more formats (e.g., secure digital (SD) card, Memory stick, compact flash, etc.).

According to various embodiments of the disclosure, the transceiver 103 may include a wireless communication module or a radio frequency (RF) module. The wireless communication module may include, for example, wireless-fidelity (Wi-Fi), Bluetooth (BT), global positioning system (GPS) or near field communication (NFC). For example, the wireless communication module may provide a wireless communication function using a radio frequency. Additionally or alternatively, the wireless communication module may include a network interface or modem for connecting the electronic device 10 with a network (e.g., Internet, LAN, WAN, telecommunication network, cellular network, satellite network, POTS or 5G network). The RF module may be responsible for data transmission/reception, e.g., transmitting and receiving data RF signals or invoked electronic signals. As an example, the RF module may include, e.g., a power amp module (PAM), a frequency filter, or a low noise amplifier (LNA). The RF module may further include parts (e.g., conductors or wires) for communicating radio waves in a free space upon performing wireless communication.

In an embodiment, the electronic device 10 may further include an additional component 104. The additional component 104 may include, but is not limited to, e.g., an output unit, such as a display or a speaker, and an input unit, such as a microphone, a mouse, or a touchscreen.

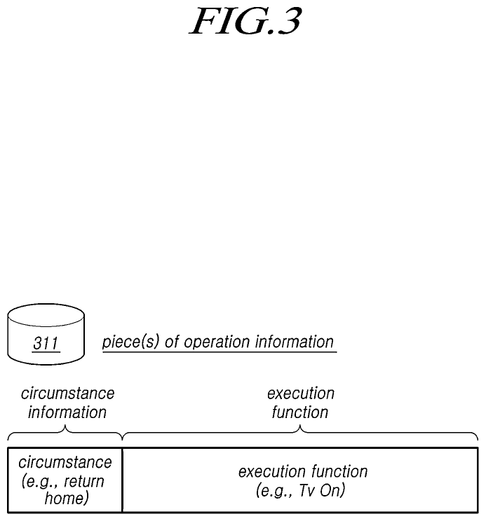

FIG. 3 is a concept view illustrating a structure of operation information.

The operation information 311 may be used for generating or managing automation reference information generated or managed by the intelligent assistant of the disclosure. The operation information 311 may be configured as a portion of automation reference information, in one example. The automation reference information, which is described below, may include the operation information 311 and reference parameter(s) associated with the operation information 311, or may be composed of them.

The operation information 311 may include a function (execution function) executable by various user devices (e.g., a first user device or a second user device), and information (e.g., event information) about an event that is the basis for the initiation of the execution function.

The operation information 311 may be created into a database and stored in the memory of the intelligent assistant.

The operation information 311 may be distinguished from each other based on event information (also referred to as “circumstance information”) and/or the execution function (or an execution function(s)). For example, a plurality of pieces of operation information 311 may be distinguished primarily based on event information (e.g., return home/go out, weekday/weekend, etc.) and secondarily based on the execution function. Further, e.g., the plurality of pieces of operation information 311 may be distinguished primarily based on the execution function and may be distinguished secondarily based on event information.

Meanwhile, the event information is information that is the basis for initiating the execution function, and may include various types of information that may be obtained contextually. For example, the event information may include at least one of time information, location information, communication status information, and/or sensing information, but is not limited thereto.

The time information represents the current time and may include, or be composed of, information about hours/minutes/seconds or information about days/months/years. Based on the time information, temporal events of the day, such as breakfast, lunch, and dinner, may be identified. Based on the time information, temporal events such as weekdays, weekends, and holidays may be identified.

The location information indicates the current locations of various user devices (e.g., a first user device and a second user device). Meanwhile, the location information may be the basis for determining whether various user devices are located in the house. For example, when the user device is detected to be located in a residence, the user device may be determined to be located in the house. For example, if the user device is detected to be located in the workplace, the user device may be determined to be located in the workplace.

The communication status information may include information about whether various user devices (e.g., the first user device and the second user device) are wirelessly communicating over the network, the type of network in wireless communication, and/or other user devices in communication. For example, when the user device is communicating over a 5G network, the communication status may be expressed as i. in communication connection, and ii. 5G cellular network. For example, when the user device is communicating with a vehicle via Bluetooth, the communication status may be expressed as i. in communication connection, ii. Bluetooth, and iii. vehicle.

The sensing information is various types of information obtained through one or more sensors equipped in various user devices. For example, the sensing information may include one or more pieces of information related to sensed images, audio, acceleration, tilt, or pressure.

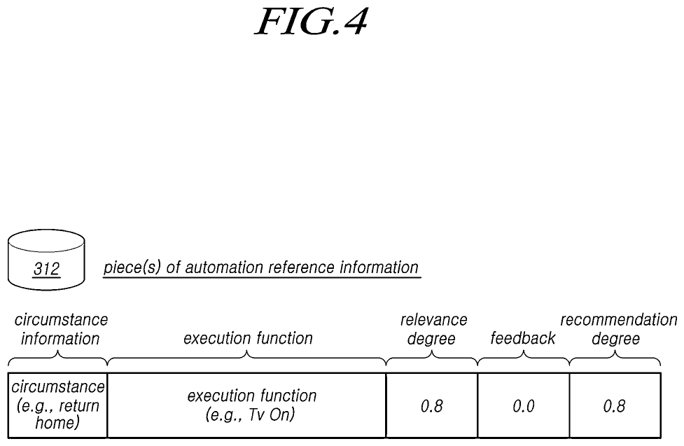

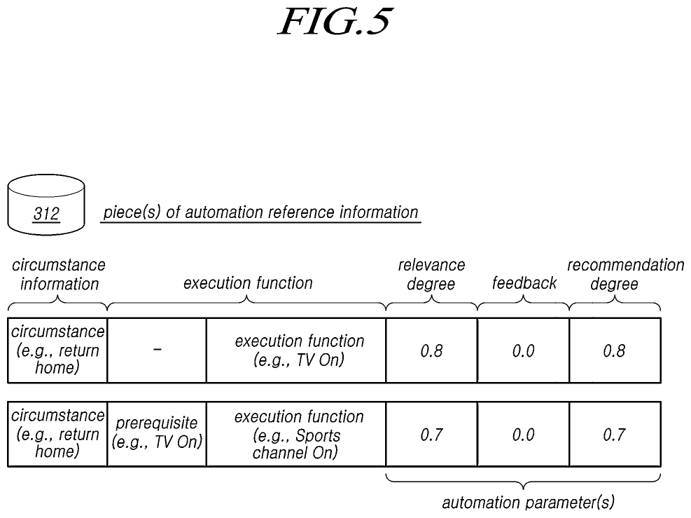

FIGS. 4 and 5 are concept views illustrating an example of a structure of automation reference information.

Referring to FIG. 4, automation reference information 312 may be the basis for determining the type of automation process. The intelligent assistant may determine an execution function to be executed based on the automation reference information 312. Further, the intelligent assistant may determine how to perform the execution function to be executed (i.e., the type of the automation process).

The automation reference information 312 may include automation parameters associated with operation information (e.g., the operation information 311 of FIG. 3) (e.g., event information and execution function). The automation parameter may be the basis for determining the type of the automation process. The automation parameters may include, e.g., relevance degree, feedback, and recommendation degree, and the type of the automation process may be determined particularly based on the recommendation degree.

In the disclosure, the relevance degree is represented as a value of a relevance between event information and an execution function. The relevance degree may be predefined by the user or may be defined as a statistically pre-calculated value.

The feedback may be calculated based on a response received from the user device. For example, when a negative response is received, the value of the feedback may represent a negative value. For example, if a positive response is received, the value of the feedback may represent a positive value.

The recommendation degree may be calculated as the sum of the relevance degree and the feedback. For example, when the relevance degree is X and the feedback is Y, the recommendation degree may be calculated as X+Y. Accordingly, even if the predefined value of the relevance degree is large, the recommendation degree may be calculated as low when negative responses are accumulated. Further, even if the predefined value of the relevance degree is small, the recommendation degree may be calculated as high when positive responses are accumulated.

This recommendation degree may be the basis for determining the type of the automation process. In an embodiment of the disclosure, the type of the automation process may be determined based on a plurality of reference values and the recommendation degree. A reference range may be defined by the plurality of reference values, and each reference range may be associated with one automation process type. By identifying the reference range to which the recommendation degree belongs, the intelligent assistant system may determine the type of the automation process.

More specifically, if arbitrary event information is detected, the intelligent assistant may identify recommendation degrees of a plurality of automation reference information 312 associated with the event information. Thereafter, the intelligent assistant may select any one of the plurality of automation reference information 312 based on the identified recommendation degree, and perform the selected reference information 312 with an automation process corresponding to the recommendation degree.

In an embodiment, the automation process refers to a method of performing one or more execution function(s). In an embodiment of the disclosure, the automation process may be divided into a plurality of types. A first type of automation process may be configured to perform an execution function associated with the event information regardless of the user's intention to execute. A second type of automation process may be configured to transmit or output a query about the user's intention to execute, and perform an execution function associated with the event information based on not receiving a negative response to the query within a predefined time. A third type of automation process may be configured to transmit or output a query about the user's intention to execute, and perform an execution function associated with the event information based on receiving a positive response to the query.

In the disclosure, a query for identifying the user's intention to execute may be referred to as a “function suggestion message”. In an embodiment, the function suggestion message may be generated by the intelligent assistant as a message for determining whether to proceed with the execution function. The function suggestion message may be generated differently based on the above-described recommendation degree. In other words, the function suggestion message may or may not be generated differently based on the type of the automation process described above.

Meanwhile, in an embodiment, there may be various execution functions according to the type of the user device. For example, in the case of a television, the execution functions may include, but are not limited to, turning on or off the television, changing the channel of the television, adjusting the volume, and changing the brightness of the screen. For example, in the case of a washer, powering on or off the washer and switching the washing mode of the washer (e.g., spin cycle, washing cycle, or rinsing cycle) may be included, but the disclosure is not limited thereto.

In an embodiment, the execution function may be associated with the event information. The execution function may be stored in the memory in a form mapped to the event information. For example, the first event information may be mapped to the first execution function, and the second event information may be mapped to the second execution function.

Referring to FIG. 5, in an embodiment, the automation reference information 312 may further include a prerequisite. The prerequisite may be associated with the execution function. The execution function may be performed based on the satisfaction of the prerequisite. In an embodiment, the prerequisite may be that the performance of another execution function is completed. For example, the execution function of controlling to output a sports channel may be performed only when a prerequisite such as TV On is maintained. As such, an execution function with a prerequisite may be referred to as a dependent execution function or a dependent function. Conversely, an execution function without a prerequisite may be referred to as an independent execution function or an independent function.

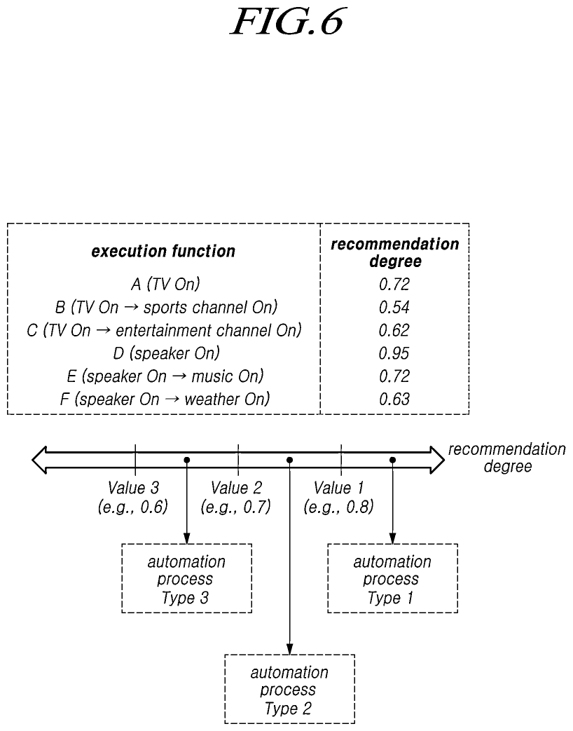

FIG. 6 is a concept view exemplarily illustrating a type of an automation process.

Referring to FIG. 6, in an embodiment, the intelligent assistant may select an Nth execution function (where N is a natural number of 1 or more) to be executed and determine the type of the automation process based on the recommendation degree associated with the selected Nth execution function. The Nth execution function where the type of the automation process is determined may be executed based on the determined type of the automation process.

In an embodiment, the automation process may be implemented in a plurality of types. For example, the automation process may be implemented in first to third types. The first to third types of automation processes may be determined based on the above-described recommendation degree. The recommendation degree may be configured as an element of automation reference information. The recommendation degree may be associated with the execution function(s).

The types of the plurality of automation processes may be determined by a predefined reference value or reference range. Without limitations thereto, in an embodiment of the disclosure, the intelligent assistant may determine the types of the automation process through N reference values and N+1 reference ranges divided by the N reference values. For example, the reference values may include a first reference value (e.g., 0.8), a second reference value (e.g., 0.7), and a third reference value (e.g., 0.6), and the reference ranges may include a range exceeding the first reference value, a range between the first reference value and the second reference value, a range between the second reference value and the third reference value, and a range less than the third reference value.

More specifically, the type of the automation process may be determined by comparing the recommendation degree with the reference value. The intelligent assistant system may determine a different automation process type depending on whether the recommendation degree exceeds the first reference value, whether it is between the first reference value and the second reference value, between the second reference value and the third reference value, or less than the third reference value. For example, when the recommendation degree exceeds the first reference value, the execution function may be executed with the first type of automation process, when it is between the first reference value and the second reference value, the execution function may be executed with the second type of automation process, and when it is between the second reference value and the third reference value, the execution function may be executed with the third type of automation process. Further, less than the third reference value, the intelligent assistant system does not use the automation process.

Meanwhile, in an embodiment, the intelligent assistant may select an execution function based on the recommendation degree. The selected execution function may be controlled to be executed by the intelligent assistant. Specifically, it may be controlled to be executed on the user device by the intelligent assistant, and the intelligent assistant may transmit a control command to the user device for that purpose.

In an embodiment, the selection of the execution function may be performed based on the device type and recommendation degree. For reference, the “device type” indicates the type of device such as a TV device, a speaker device, a refrigerator, and an air conditioner.

In an embodiment, the intelligent assistant may divide execution functions based on the device type. For example, some of the plurality of execution functions may be classified as associated with the first user device (e.g., TV device), and others may be classified as associated with the second user device (e.g., speaker device). In the disclosure, execution functions associated with the first user device may be referred to as an execution function group, and execution functions associated with the second user device may be referred to as a second execution function group.

In an embodiment, the intelligent assistant may select any one of one or more execution function(s) constituting the execution function group as a primary execution function. For example, the intelligent assistant may identify recommendation degrees associated with one or more execution function(s) that constitute the execution function group and select the execution function associated with the largest recommendation degree as the primary execution function.

In an embodiment, the intelligent assistant may select any one of one or more execution function(s) constituting the execution function group as a secondary execution function based on completion of execution of the primary execution function.

The secondary execution function may be selected as similar to or substantially the same as the primary execution function. In response to the completion of the execution of the primary execution function, the intelligent assistant may identify automation reference information that has the completion of the execution of the primary execution function as a prerequisite.

For example, the intelligent assistant may identify execution function B to “change to sports channel” and execution function C to “change to entertainment channel”, which have the prerequisite that execution function A to “turn on TV” should precede, as automation reference information. Execution function B and execution function C having a common prerequisite may form an execution function group together with execution function A, and one of them may be selected as a secondary execution function.

For example, the intelligent assistant may identify the recommendation degree of the execution functions constituting the execution function group and select the execution function associated with the second largest recommendation degree as the secondary execution function. As such, by selecting the execution function associated with the second largest recommendation degree, the pre-selected primary execution function may be excluded in the process of selecting the secondary execution function.

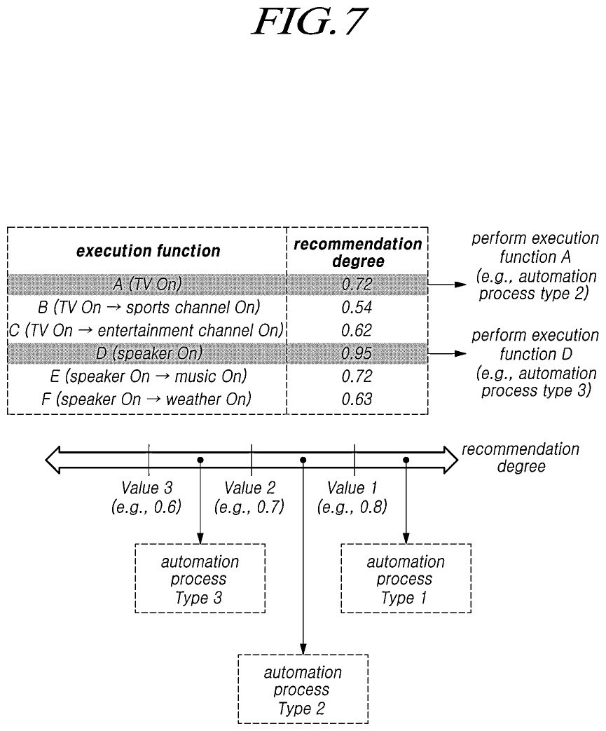

FIG. 7 is a reference view illustrating a process of performing a primary execution function based on a recommendation degree.

Referring to FIG. 7, the intelligent assistant may determine at least one of execution functions as the primary execution function based on the recommendation degree. For example, the intelligent assistant may determine the execution function associated with the recommendation degree having the largest value as the primary execution function.

In an embodiment, the intelligent assistant may select execution functions whose associated recommendation degree is larger than or equal to a predefined value, and determine the primary execution function based on the size of the recommendation degree associated with the selected execution functions. The predefined value may be any one of the plurality of reference values, preferably the smallest of the plurality of reference values, but is not limited thereto.

In an embodiment, the primary execution function may be determined from among execution functions without a prerequisite. As described above with reference to FIG. 4, an execution function may be associated with one or more prerequisites, and an execution condition irrelevant to the prerequisite may be referred to as an independent execution function, and an execution condition associated with one or more prerequisites may be referred to as a dependent execution function. In other words, in an embodiment, the primary execution function may be determined as any one of independent execution functions.

In an embodiment, the intelligent assistant may generate an execution function group based on the device type and determine any one of one or more execution functions belonging to the execution function group as the primary execution function. For example, the intelligent assistant may divide execution functions A, B, and C related to the TV device into one execution function group and execution functions D, E, and F related to the speaker device into another execution function group based on the device type.

The intelligent assistant may determine an independent execution function among execution functions included in the execution function group as an execution function. When there are a plurality of independent execution functions in one execution function group, the intelligent assistant may determine the one having the highest recommendation degree among the plurality of independent execution functions as the primary execution function.

For example, the execution function group related to the TV device includes execution function A, execution function B, and execution function C. Here, since execution function A is an independent execution function, and execution function B and execution function C are dependent execution functions, the intelligent assistant may determine execution function A as the primary execution function.

Further, e.g., the execution function group related to the speaker device includes execution function D, execution function E, and execution function F. Here, since execution function D is an independent execution function, and execution function E and execution function F are dependent execution functions, the intelligent assistant may determine execution function D as the primary execution function.

On the other hand, if other independent execution functions are further included in the execution function group associated with the speaker device, the intelligent assistant may determine the execution function with a larger value as the primary execution function based on the recommendation degree associated with each of the independent execution functions.

In an embodiment, when there are a plurality of execution function groups, a plurality of primary execution functions may be present. For example, one primary execution function may be determined from the execution function group related to the TV device, and another primary execution function may be determined from the execution function group related to the speaker device. As described above, when there are a plurality of primary execution functions, the plurality of primary execution functions may be executed in parallel by the intelligent assistant. For example, in response to detection of a predetermined event, the intelligent assistant may independently perform execution function A (“TV ON”) and execution function D (“speaker ON”).

Referring back to FIG. 7, since execution function A executed at this time has a recommendation degree of 0.72, execution function A may be executed through the second type of automation process based on the illustrated reference values. Further, since execution function D executed separately from execution function A has a recommendation degree of 0.95, execution function D may be executed through the third type of automation process based on the illustrated reference values.

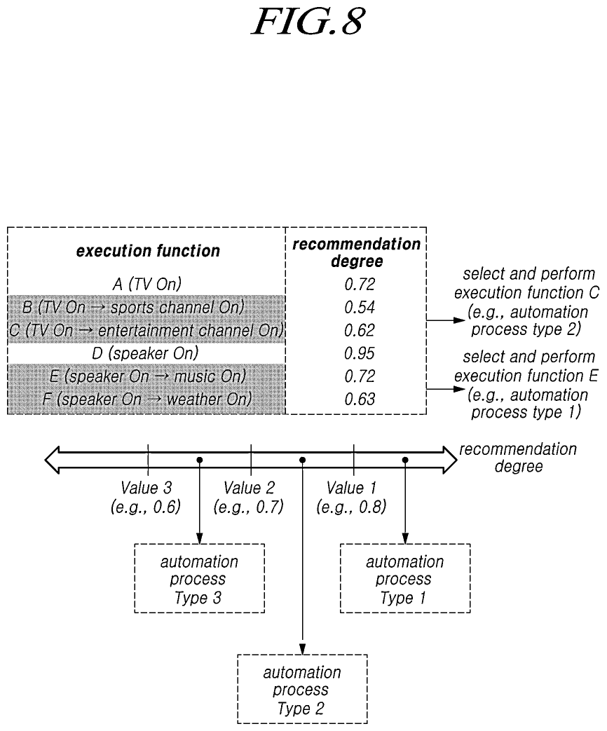

FIG. 8 is a reference view illustrating a process of performing a secondary execution function based on a recommendation degree.

Referring to FIG. 8, the intelligent assistant may execute the Mth execution function (where M is N+1) based on the completion of the execution of the Nth execution function (where N is a natural number of 1 or more).

In an embodiment, if the Nth execution function is executed, the intelligent assistant may identify a dependent execution function having the completion of the execution of the Nth execution function as a prerequisite. More specifically, the intelligent assistant may identify one or more dependent execution functions having the execution of the Nth execution function among a plurality of intelligent execution functions as a prerequisite. The intelligent assistant may determine the Mth execution function based on the identified recommendation degrees of the dependent execution functions. Among the dependent execution functions, the one having the highest recommendation degree may be determined as the Mth execution function.

In an embodiment, if the primary execution function is executed, the intelligent assistant may identify a dependent execution function using the completion of the execution of the primary execution function as a prerequisite.

For example, when the execution function (execution function A) to “turn on the TV” is completed, the intelligent assistant may identify dependent execution functions such as execution function B and execution function C having the completion of the execution function to “turn on the TV” as a prerequisite. Thereafter, the intelligent assistant may compare the recommendation degrees of execution function B and execution function C to determine execution function C having a larger value as the Mth execution function.

As another example, when the execution function (execution function D) to “turn on the speaker” is completed, the intelligent assistant may identify dependent execution functions such as execution function E and execution function F, which have the completion of the execution of the execution function to “turn on the speaker” as a prerequisite. Thereafter, the intelligent assistant may compare the recommendation degrees of execution function E and execution function F to determine execution function E having a larger value as the Mth execution function.

In the following disclosure, an example of performing an execution function based on the type of the automation processes is described. In an embodiment of the disclosure, the intelligent assistant may generate a function suggestion message or a guide message based on the type of the automation process. Here, the function suggestion message and the guide message may be transmitted to at least one user device.

The function suggestion message may be composed of a query for identifying the user's intention to execute, regarding the Nth execution function (where N is a natural number of 1 or more). The function suggestion message may be generated differently based on the type of the automation process. In other words, the function suggestion message may be generated differently based on the recommendation degree associated with the execution function. Further, when the recommendation degree is less than a predefined reference value, a function suggestion message is not generated.

For example, when it is determined as the first type of automation process, a function suggestion message is not generated. For example, if it is determined as the second type of automation process, a first type of function suggestion message may be generated. For example, if it is determined as the third type of automation process, a second type of function suggestion message may be generated.

The function suggestion message of the first type may include or be composed of text and/or an image that predicts the execution of the execution function. For example, the first type of function suggestion message may include a phrase such as “The device will be turned on.”

The second type of function suggestion message may include or be composed of text and/or an image inquiring execution of the execution function. For example, the second type of function suggestion message may include a query phrase such as “Do you want to turn on the device?” The second type of function suggestion message may further include a graphic element for identifying the user's intention as either positive or negative, such as “O” and “X” adjacent to the query phrase.

According to an embodiment, the first and second types of function suggestion messages may further include a device icon indicating the device type associated with the execution function. The device icon may be composed of an image for schematically representing the type of device.

Meanwhile, in an embodiment, the guide message is a message indicating the completion of the execution, and may include text and/or an image regarding the completion of the execution function. For example, a guide message regarding the execution function to “power on the TV device” may be composed of a phrase such as “The TV has been turned on.”

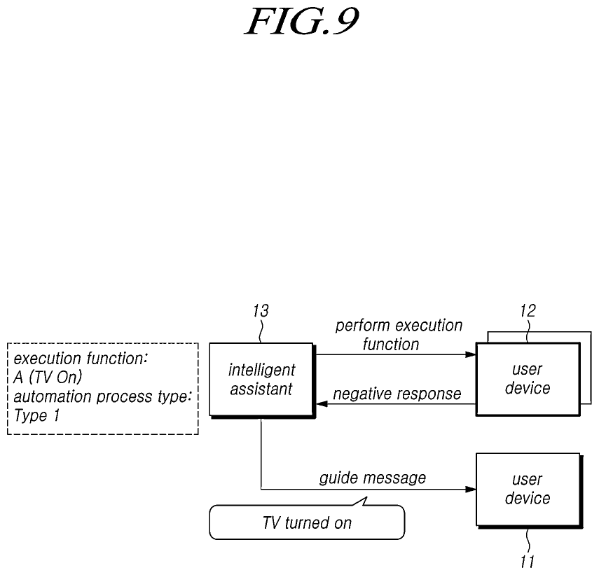

Hereinafter, an example of performing an execution function according to an embodiment is described with reference to FIGS. 9 to 11.

FIG. 9 illustrates an example of performing an execution function based on a first type of automation process applied to an embodiment.

In an embodiment, the intelligent assistant 13 may be wiredly/wirelessly connected to one or more user devices. The user device may be divided into a control target device where the execution function is controlled by the intelligent assistant 13 and an external control device that commands the intelligent assistant 13 to perform the execution function.

The control target device includes the user device capable of implementing the execution function(s) of the disclosure. For example, the control target device may include, but is not limited to, a home appliance, an IoT device, a sensor device, a lighting device, or the like.

Further, the external control device includes a device that generates or transmits a control command(s) for the execution function(s) of the disclosure to be implemented through the above-described control target device. For example, the external control device may include a wireless terminal, more preferably a smartphone, a tablet PC, an XR device, a smart watch, or the like, but is not limited thereto.

In an embodiment, the external control device may be directly wiredly or wirelessly connected to the control target device, or may be wiredly or wirelessly connected to the control target device through the intelligent assistant 13. The external control device may control the user device to perform the execution function of the disclosure, either directly or through the intelligent assistant 13.

In the following disclosure, the control target device is referred to as a first user device 11, and the external control device is referred to as a second user device 12.

Referring to FIG. 9, in an embodiment, the intelligent assistant 13 may identify the recommendation degree associated with the execution function. The intelligent assistant 13 may control the first user device 11 to perform at least one of a plurality of execution functions based on the recommendation degree. For example, the intelligent assistant 13 may transmit a command(s) to control the first user device 11 to perform the identified execution function based on the recommendation degree.

In an embodiment, the intelligent assistant 13 may determine the type of the automation process associated with the execution function as any one of the first to third types of automation processes based on the recommendation degree. In an embodiment, the intelligent assistant system may determine the first type of automation process as an automation process associated with the execution function when the recommendation degree exceeds a predefined first reference value.

In an embodiment, the execution function may be performed by the first user device 11 according to the determined type (i.e., the first type) of automation process. For example, the intelligent assistant 13 may generate a first control command for controlling the first user device 11 to perform an execution function based on the first type of automation process. The intelligent assistant system may wiredly or wirelessly transmit the generated first control command to the first user device 11.

In an embodiment, based on receiving the first control command, the first user device 11 may perform an execution function associated with the first control command. For example, when the execution function is “TV On”, the first user device 11 (e.g., a TV device) may turn on the power.

In an embodiment, the first user device 11 may transmit a response to the first control command to the intelligent assistant 13. For example, the first user device 11 may obtain a first response to the first control command for a predetermined time based on receiving the first control command. Here, the first response may be configured as at least a portion of the user input received for a predefined time.

In an embodiment, the first user device 11 may activate the first feedback window for a predefined time based on receiving the first control command. It may be the basis for determining the attribute of the user's first response received while the first feedback window is maintained in an active state.

In an embodiment, when the first user device 11 maintains the execution function corresponding to the first control command while the feedback window is maintained in the active state, the attribute of the first response may be determined as positive feedback. In an embodiment, when the execution function corresponding to the first control command is not maintained while the feedback window is maintained in the active state, i.e., when the first user device 11 receives a user input for performing another execution function, the attribute of the first response may be determined as negative feedback.

In an embodiment, the intelligent assistant 13 may update the automation reference information based on the first response (e.g., positive feedback or negative feedback). As described above, the automation parameters of the automation reference information may include relevance degree, feedback, and recommendation degree. The intelligent assistant 13 may update the value of the feedback based on the first response. For example, the intelligent assistant 13 may increase the value of the feedback based on receiving the positive feedback and decrease the value of the feedback based on receiving the negative feedback. As the value of the feedback is changed by the first response as described above, the recommendation degree constituted of the sum of the relevance degree and the feedback may also be changed.

Without limitations thereto, in an embodiment, the intelligent assistant 13 may set the feedback value to 0 when positive feedback is received as the first response and set a negative feedback value when negative feedback is received. In other words, the intelligent assistant 13 may update the automation parameter in a direction of decreasing the recommendation degree only when negative feedback is received.

As illustrated with reference to FIG. 9, the intelligent assistant 13 may determine the automation process of execution function A (e.g., TV On) as the first type based on the recommendation degree. The first type of automation process does not transmit a function suggestion message to the first user device 11 or the second user device 12, but transmits a guide message to the second user device 12. The guide message may be composed of a phrase (e.g., “TV turned on”) indicating the completion of execution of execution function A.

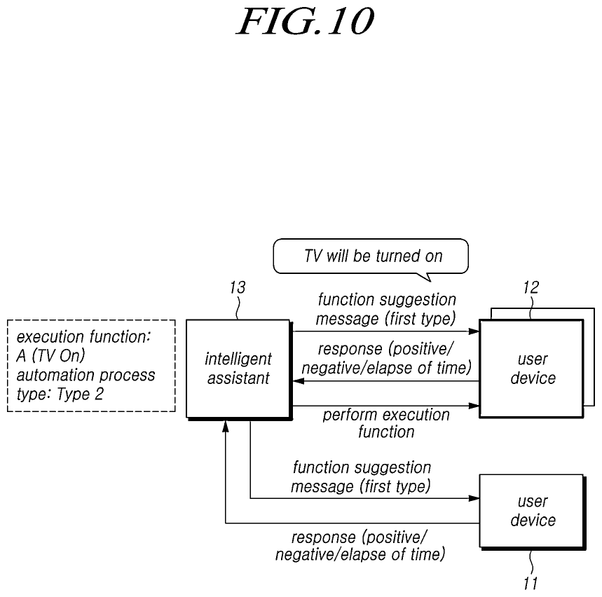

FIG. 10 illustrates an example of performing an execution function based on a second type of automation process applied to an embodiment.

Referring to FIG. 10, the intelligent assistant 13, the first user device 11, and the second user device 12 may be understood as substantially the same as the above-described blocks of FIG. 9.

In an embodiment, the intelligent assistant 13 may identify a recommendation degree associated with an execution function. The intelligent assistant 13 may control the first user device 11 to perform at least one of a plurality of execution functions based on the recommendation degree. In an embodiment, the intelligent assistant 13 may transmit a second control command to enable the first user device 11 to perform the execution function to the first user device 11. The second control command is associated with the second type of automation process.

As described above, the intelligent assistant 13 may determine an automation process for performing an execution function based on the recommendation degree. In an embodiment, when the recommendation degree is between a predefined first reference value and a predefined second reference value, the intelligent assistant 13 may determine the type of the automation process as the second type.

The intelligent assistant 13 operating based on the second type of automation process may transmit a second control command and/or a first type of function suggestion message to the first user device 11. The first user device 11 may transmit a first response to the intelligent assistant 13 in response to the second control command and/or the first type of function suggestion message.

Further, the intelligent assistant 13 operating based on the second type of automation process may transmit the first type of function suggestion message to the second user device 12. The second user device 12 may transmit a second response to the intelligent assistant 13 in response to the first type of function suggestion message. The intelligent assistant 13 may transmit the first control command described above with reference to FIG. 9 to the first user device 11 based on the second response received from the second user device 12.

Meanwhile, the first type of function suggestion message may include or be composed of text and/or an image that predicts the execution of the execution function. The first type of function suggestion message may be understood as an execution prediction message. The first type of function suggestion message may be composed of, e.g., a prediction phrase such as “TV will be turned on.”

In an embodiment, the first user device 11 may display the first type of function suggestion message on the display based on receiving the first type of function suggestion message. For example, the prediction phrase constituting the first type of function suggestion message may be displayed on the display.

In an embodiment, the first user device 11 may activate the second feedback window for a predetermined time based on receiving a second control command from the intelligent assistant 13. The user input received by the first user device 11 while the second feedback window is activated may be the basis for determining the attribute of the first response to be transmitted to the intelligent assistant 13.

In an embodiment, the first user device 11 may determine the attribute of the first response as either positive feedback or neutral feedback based on not receiving a user input while a predetermined time when the second feedback window is activated elapses.

In an embodiment, the first user device 11 may determine the attribute of the first response as negative feedback based on receiving a user input for changing the execution function for a predetermined time when the second feedback window is activated.

In an embodiment, the intelligent assistant 13 may increase the feedback value of the automation parameter based on receiving the positive feedback and decease the feedback value of the automation parameter based on receiving the negative feedback. Further, the intelligent assistant 13 may maintain and adjust the feedback value of the automation parameter based on the neutral feedback being received (e.g., determine the feedback value as +0.00).

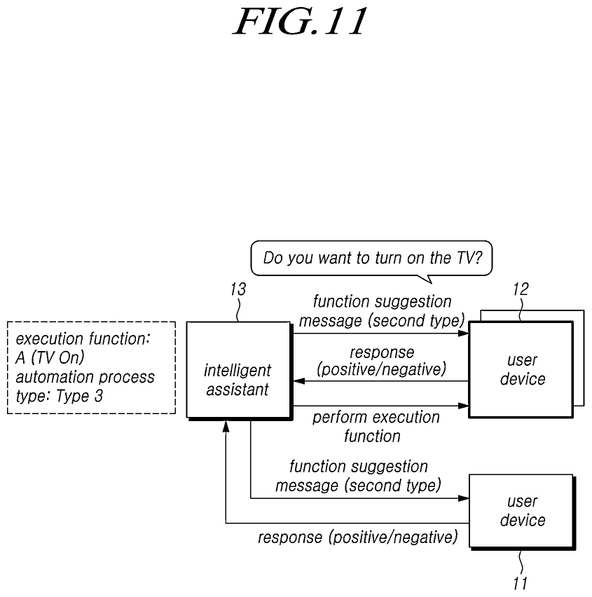

FIG. 11 illustrates an example of performing an execution function based on a third type of automation process applied to an embodiment.

Referring to FIG. 11, the intelligent assistant 13, the first user device 11, and the second user device 12 may be understood as substantially the same as the above-described blocks of FIG. 9.

In an embodiment, the intelligent assistant 13 may identify a recommendation degree associated with an execution function. The intelligent assistant 13 may control the first user device 11 to perform at least one of a plurality of execution functions based on the recommendation degree. In an embodiment, the intelligent assistant 13 may transmit a third control command to enable the first user device 11 to perform the execution function to the first user device 11. The third control command is associated with the third type of automation process.

As described above, the intelligent assistant 13 may determine an automation process for performing an execution function based on the recommendation degree. In an embodiment, when the recommendation degree is between a predefined second reference value and a predefined third reference value, the intelligent assistant 13 may determine the type of the automation process as the third type.

The intelligent assistant 13 operating based on the third type of automation process may transmit a third control command and/or a second type of function suggestion message to the first user device 11. The first user device 11 may transmit a first response to the intelligent assistant 13 in response to the third control command and/or the second type of function suggestion message.

Further, the intelligent assistant 13 operating based on the third type of automation process may transmit the second type of function suggestion message to the second user device 12. The second user device 12 may transmit a second response to the intelligent assistant 13 in response to the second type of function suggestion message. The intelligent assistant 13 may transmit the first control command described above with reference to FIG. 9 to the first user device 11 based on the second response received from the second user device 12.

Meanwhile, the second type of function suggestion message may include or be composed of text and/or an image inquiring execution of the execution function. For example, the second type of function suggestion message may include a query phrase such as “Do you want to turn on the device?” The second type of function suggestion message may further include a graphic element for identifying the user's intention as either positive or negative, such as “O” and “X” adjacent to the query phrase.

In an embodiment, the first user device 11 may display the second type of function suggestion message on the display based on receiving the second type of function suggestion message. For example, the query phrase included in the second type of function suggestion message may be displayed on the display.

In an embodiment, the first user device 11 may activate the third feedback window for a predetermined time based on receiving a third control command from the intelligent assistant 13. The user input received by the first user device 11 while the third feedback window is activated may be the basis for determining the attribute of the first response to be transmitted to the intelligent assistant 13.

In an embodiment, the first user device 11 may determine the attribute of the first response as either positive feedback or neutral feedback based on not receiving a user input while a predetermined time when the third feedback window is activated elapses.

In an embodiment, the first user device 11 may determine the attribute of the first response as negative feedback based on receiving a user input for changing the execution function for a predetermined time when the second feedback window is activated.

In an embodiment, the intelligent assistant 13 may increase the feedback value of the automation parameter based on receiving the positive feedback and decease the feedback value of the automation parameter based on receiving the negative feedback. Further, the intelligent assistant 13 may maintain and adjust the feedback value of the automation parameter based on the neutral feedback being received (e.g., determine the feedback value as +0.00).

Referring back to FIGS. 9 to 12, in an embodiment, the first response may be configured differently based on the type of the automated process. The first response refers to the response transmitted by the first user device 11 to the intelligent assistant 13. In an embodiment of the disclosure, the first response may include positive feedback or negative feedback when a first type of automation process is applied. Further, the first response may include positive feedback, negative feedback, or neutral feedback when the second type of automation process is applied. Further, the first response may include positive feedback or negative feedback when the third type of automation process is applied. On the other hand, without limitations thereto, when the first type of automation process is applied, the first response may be composed of only negative feedback.

In an embodiment, the second response may be configured differently based on the type of the automation process. The second response refers to the response transmitted by the second user device 12 to the intelligent assistant 13. In an embodiment of the disclosure, the second response may include positive feedback or negative feedback when a first type of automation process is applied. Further, the second response may include positive feedback, negative feedback, or neutral feedback when the second type of automation process is applied. Further, the second response may include positive feedback or negative feedback when the third type of automation process is applied. On the other hand, without limitations thereto, when the first type of automation process is applied, the first response may be composed of only negative feedback.

In an embodiment, the second response may be configured as substantially identical to the first response, but is not limited thereto. In an embodiment, the intelligent assistant 13 may determine whether to transmit a first control command to the first user device 11 in response to receiving the second response. For example, the intelligent assistant 13 may transmit the first control command to the first user device 11 based on receiving the second response including positive feedback. For example, the intelligent assistant 13 may transmit the first control command to the first user device 11 based on receiving the second response including neutral feedback. For example, the intelligent assistant 13 does not transmit the first control command to the first user device 11 based on receiving the second response including negative feedback.

In an embodiment, when the automation process is determined as the third type, the third control command may include one or more instructions controlling the first or second user device 11 or 12 to output text information constituting the second type of function suggestion message as a voice. To that end, the intelligent assistant may include an operation of determining a speech pattern of a voice output based on automation reference information (e.g., a recommendation degree).

The speech pattern may include, but is not limited to, at least one of a frequency, a pitch, an utterance time, an utterance speed, an inter-phrase time width, or an inter-word time width. In an embodiment, as a recommendation degree of the automation reference information decreases, at least one of the inter-phrase time width or the inter-word time width may increase. Further, as the recommendation degree of the automation reference information increases, the speech pattern may be composed of downward intonation, and as the recommendation degree of the automation reference information decreases, the speech pattern may be composed of upward intonation.

Further, according to an embodiment, the first or second user device 11 or 12 may output the second type of function suggestion message through an output unit (e.g., a display, or a speaker) based on receiving the second control command and the second type of function suggestion message. For example, when displaying the second type of function suggestion message through the display, the first or second user device 11 or 12 may display a positive virtual key (e.g., a YES button) and a negative virtual key (e.g., a NO button) together to identify the user's intention. In an embodiment, the first or second user device 11 or 12 may determine the size of the positive virtual key or the negative virtual key based on the recommendation degree. For example, as the recommendation degree increases, the size of the positive virtual key may be set to be larger, and as the recommendation degree decreases, the size of the negative virtual key may be set to be larger.

Meanwhile, according to an embodiment, the intelligent assistant 13 may perform a plurality of execution functions with one type of the automation process, unlike described above with reference to FIGS. 7 to 9. In other words, unlike performing the first to Mth execution functions with the respective associated types of automation processes, the intelligent assistant 13 may perform the plurality of related execution functions with one type of automation process.

Referring back to FIG. 4, the automation reference information may include one or more execution functions. In an embodiment, the automation reference information may include a plurality of execution functions. The plurality of execution functions configuring the automation reference information may be sequentially performed based on predefined priority. For example, when three execution functions are included in one piece of automation reference information, each execution function may be performed in the order of first, second, and third, according to the priority. Here, the priority which is the basis for determining the order may be predefined by the user or the service provider, but is not limited thereto.

Although not limited thereto, in an embodiment, substantially the same or different types of automation processes may be applied to each of the plurality of execution functions sequentially performed based on the respective recommendation degrees. For example, without limitations thereto, if the automation reference information includes execution function A, execution function B, and execution function C defined to be performed sequentially, execution function A may be performed with the first type of automation process, execution function B may be performed with the second type of automation process, and execution function C may be performed with the third type of automation process. To that end, the automation reference information composed of a plurality of execution functions may further include automation parameters associated with each execution function.

In an embodiment, there may be two or more execution functions (e.g., dependent execution functions) defined with substantially the same priority. For example, there may be two or more secondary execution functions to be performed based on the completion of the primary execution function. In this case, the intelligent assistant 13 may determine any one of two or more dependent execution functions having the same priority based on the automation parameter. For example, if there is secondary execution function A (recommendation degree 0.8) and secondary execution function B (recommendation degree 0.7), the intelligent assistant 13 may determine execution function A having a larger recommendation degree as the execution target.

Meanwhile, in an embodiment, the automation reference information may include an automation parameter associated with a group of execution functions. In this case, the automation reference information does not include automation parameters associated with each execution function. The automation parameter associated with the group of execution functions may be referred to as a group automation parameter.

In an embodiment, the automation reference information may determine the type of the automation parameter to be commonly applied to a plurality of execution functions, based on the group automation parameter. For example, the intelligent assistant 13 may apply any one of the first to third types of automation parameters to the group of execution functions.

In an embodiment, the group of execution functions may be sequentially executed based on one control command. For example, the first user device 11 and/or the second user device 12 may sequentially perform the group of execution functions according to priority based on receiving a control command from the intelligent assistant 13. For example, when receiving a first control command associated with the first type of automation process, the first user device 11 may sequentially execute the group of execution functions. For example, when receiving a second control command associated with the second type of automation process, the first user device 11 may sequentially perform the group of execution functions based on the lapse of a predefined time. For example, when receiving a third control command associated with the third type of automation process, the first user device 11 may sequentially perform the group of execution functions based on the user's intention.

On the other hand, in this case, the group of execution functions is performed based on one type of the automation process, so that the function suggestion message may also be composed of one message associated with the group of execution functions. For example, the function suggestion message associated with the group of execution functions may include text and/or images associated with all of the execution functions. More specifically, a function suggestion message including an execution function to “power on the TV device” and an execution function to “switch to a sports channel” may be composed of a query about executing all of the group of execution functions. For example, the function suggestion message may be made with a phrase such as “Sports channel will be turned on TV” or “Do you want to turn on a sports channel on TV?”

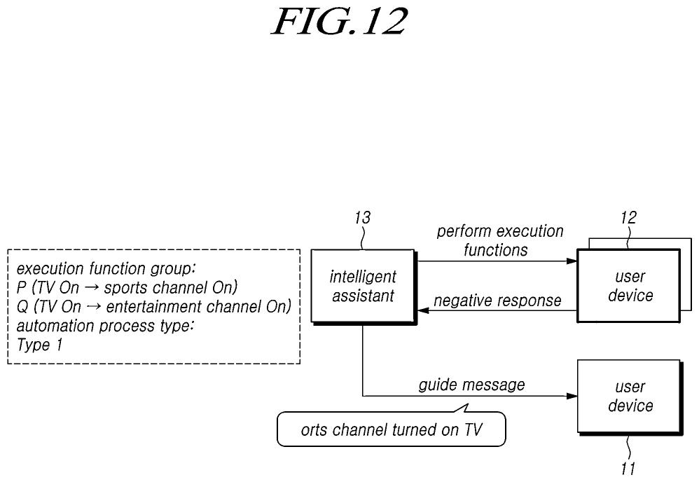

Hereinafter, a method for sequentially performing a group of execution functions through transmission of a single control command is described with reference to FIGS. 12 to 14.

FIG. 12 illustrates an example of performing an execution function based on a first type of automation process applied to an embodiment.

Referring to FIG. 12, the intelligent assistant 13, the first user device 11, and the second user device 12 may be understood to be substantially the same as the above-described blocks of FIG. 9.

In an embodiment, the intelligent assistant 13 may identify a recommendation degree associated with a group of execution functions. The intelligent assistant 13 may control the first user device 11 to perform at least one of the group of execution functions based on the recommendation degree. For example, the intelligent assistant 13 may transmit a command(s) to control the first user device 11 to perform the identified group of execution functions based on the recommendation degree.

In an embodiment, the intelligent assistant 13 may determine the type of the automation process associated with the group execution functions as any one of the first to third types of automation processes based on the recommendation degree. In an embodiment, the intelligent assistant system may determine the first type of automation process as an automation process associated with the group of execution functions when the recommendation degree exceeds a predefined first reference value.

In an embodiment, the group of execution functions may be performed by the first user device 11 according to the determined type (i.e., the first type) of automation process. For example, the intelligent assistant 13 may generate a first control command for controlling the first user device 11 to perform the group of execution functions based on the first type of automation process. The intelligent assistant system may wiredly or wirelessly transmit the generated first control command to the first user device 11.

In an embodiment, based on receiving the first control command, the first user device 11 may perform the group of execution functions associated with the first control command. For example, when the group of execution functions are “TV On” and “Sports channel On,” the first user device 11 (e.g., a TV device) may turn on the power and, as a subsequent procedure, turn on the sports channel.

In an embodiment, the first user device 11 may transmit a response to the first control command to the intelligent assistant 13. For example, the first user device 11 may obtain a first response to the first control command for a predetermined time based on receiving the first control command. Here, the first response may be configured as at least a portion of the user input received for a predefined time.

In an embodiment, the first user device 11 may activate the first feedback window for a predefined time based on receiving the first control command. It may be the basis for determining the attribute of the user's first response received while the first feedback window is maintained in an active state.

In an embodiment, when the first user device 11 maintains the group of execution functions corresponding to the first control command while the feedback window is maintained in the active state, the attribute of the first response may be determined as positive feedback. In an embodiment, when the group of execution functions corresponding to the first control command are not maintained while the feedback window is maintained in the active state, i.e., when the first user device 11 receives a user input for performing another group of execution functions, the attribute of the first response may be determined as negative feedback.

In an embodiment, the intelligent assistant 13 may update the automation reference information based on the first response (e.g., positive feedback or negative feedback). As described above, the automation parameters of the automation reference information may include relevance degree, feedback, and recommendation degree. The intelligent assistant 13 may update the value of the feedback based on the first response. For example, the intelligent assistant 13 may increase the value of the feedback based on receiving the positive feedback and decrease the value of the feedback based on receiving the negative feedback. As the value of the feedback is changed by the first response as described above, the recommendation degree constituted of the sum of the relevance degree and the feedback may also be changed.

Without limitations thereto, in an embodiment, the intelligent assistant 13 may set the feedback value to 0 when positive feedback is received as the first response and set a negative feedback value when negative feedback is received. In other words, the intelligent assistant 13 may update the automation parameter in a direction of decreasing the recommendation degree only when negative feedback is received.

As illustrated with reference to FIG. 12, the intelligent assistant 13 may determine the automation process of a group of execution functions P (e.g., “TV On” and “Sports channel On”) as the first type based on the recommendation degree. The first type of automation process does not transmit a function suggestion message to the first user device 11 or the second user device 12, but transmits a guide message to the second user device 12. The guide message may be composed of a phrase (e.g., “Sports channel has been turned on TV”) indicating the completion of execution of the group of execution functions P.

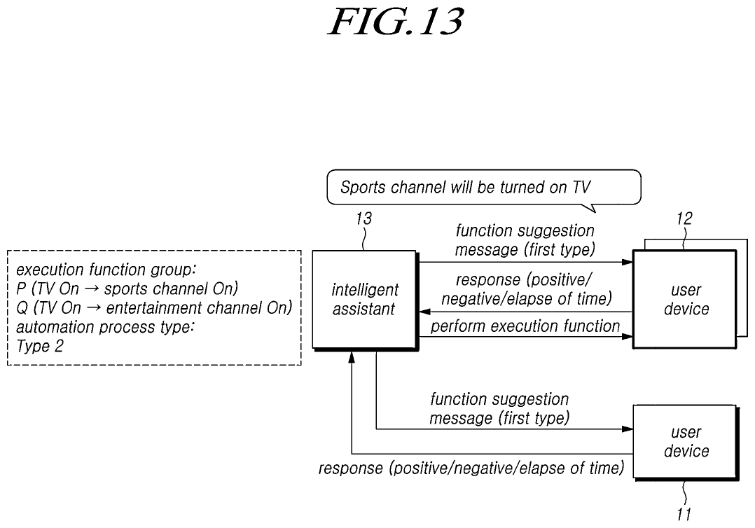

FIG. 13 illustrates an example of performing an execution function based on a second type of automation process applied to an embodiment.

Referring to FIG. 13, the intelligent assistant 13, the first user device 11, and the second user device 12 may be understood as substantially the same as the above-described blocks of FIG. 9.

In an embodiment, the intelligent assistant 13 may identify a recommendation degree associated with a group of execution functions. The intelligent assistant 13 may control the first user device 11 to perform at least one of the group of execution functions based on the recommendation degree. In an embodiment, the intelligent assistant 13 may transmit a second control command to enable the first user device 11 to perform the group of execution functions to the first user device 11. The second control command is associated with the second type of automation process.

As described above, the intelligent assistant 13 may determine an automation process for performing a group of execution functions based on the recommendation degree. In an embodiment, when the recommendation degree is between a predefined first reference value and a predefined second reference value, the intelligent assistant 13 may determine the type of the automation process as the second type.

The intelligent assistant 13 operating based on the second type of automation process may transmit a second control command and/or a first type of function suggestion message to the first user device 11. The first user device 11 may transmit a first response to the intelligent assistant 13 in response to the second control command and/or the first type of function suggestion message.

Further, the intelligent assistant 13 operating based on the second type of automation process may transmit the first type of function suggestion message to the second user device 12. The second user device 12 may transmit a second response to the intelligent assistant 13 in response to the first type of function suggestion message. The intelligent assistant 13 may transmit the first control command described above with reference to FIG. 9 to the first user device 11 based on the second response received from the second user device 12.

Meanwhile, the first type of function suggestion message may include or be composed of text and/or an image that predicts the execution of a group of execution functions. The first type of function suggestion message may be understood as an execution prediction message. The first type of function suggestion message may be composed of, e.g., a prediction phrase such as “Sports channel will be turned on TV.”

In an embodiment, the first user device 11 may display the first type of function suggestion message on the display based on receiving the first type of function suggestion message. For example, the prediction phrase constituting the first type of function suggestion message may be displayed on the display.

In an embodiment, the first user device 11 may activate the second feedback window for a predetermined time based on receiving a second control command from the intelligent assistant 13. The user input received by the first user device 11 while the second feedback window is activated may be the basis for determining the attribute of the first response to be transmitted to the intelligent assistant 13.

In an embodiment, the first user device 11 may determine the attribute of the first response as either positive feedback or neutral feedback based on not receiving a user input while a predetermined time when the second feedback window is activated elapses.

In an embodiment, the first user device 11 may determine the attribute of the first response as negative feedback based on receiving a user input for changing a group of execution functions for a predetermined time when the second feedback window is activated.

In an embodiment, the intelligent assistant 13 may increase the feedback value of the automation parameter based on receiving the positive feedback and decease the feedback value of the automation parameter based on receiving the negative feedback. Further, the intelligent assistant 13 may maintain and adjust the feedback value of the automation parameter based on the neutral feedback being received (e.g., determine the feedback value as +0.00).

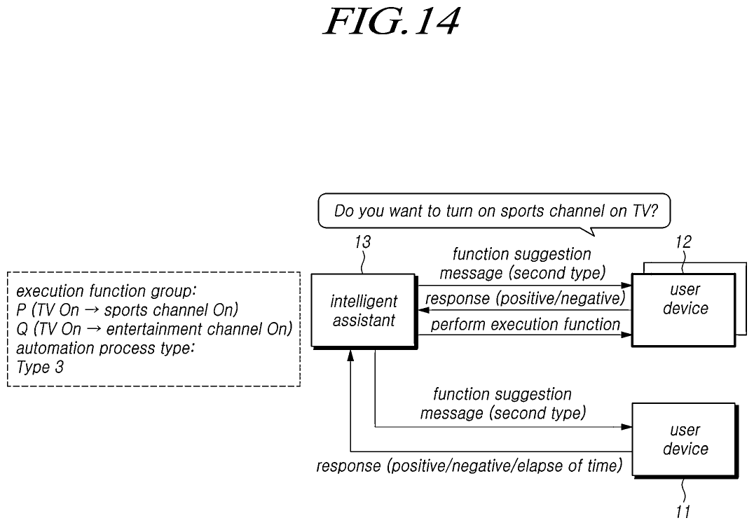

FIG. 14 illustrates an example of performing an execution function based on a third type of automation process applied to an embodiment.

Referring to FIG. 14, the intelligent assistant 13, the first user device 11, and the second user device 12 may be understood as substantially the same as the above-described blocks of FIG. 9.

In an embodiment, the intelligent assistant 13 may identify a recommendation degree associated with a group of execution functions. The intelligent assistant 13 may control the first user device 11 to perform at least one of the group of execution functions based on the recommendation degree. In an embodiment, the intelligent assistant 13 may transmit a third control command to enable the first user device 11 to perform the group of execution functions to the first user device 11. The third control command is associated with the third type of automation process.

As described above, the intelligent assistant 13 may determine an automation process for performing a group of execution functions based on the recommendation degree. In an embodiment, when the recommendation degree is between a predefined second reference value and a predefined third reference value, the intelligent assistant 13 may determine the type of the automation process as the third type.

The intelligent assistant 13 operating based on the third type of automation process may transmit a third control command and/or a second type of function suggestion message to the first user device 11. The first user device 11 may transmit a first response to the intelligent assistant 13 in response to the third control command and/or the second type of function suggestion message.

Further, the intelligent assistant 13 operating based on the third type of automation process may transmit the second type of function suggestion message to the second user device 12. The second user device 12 may transmit a second response to the intelligent assistant 13 in response to the second type of function suggestion message. The intelligent assistant 13 may transmit the first control command described above with reference to FIG. 9 to the first user device 11 based on the second response received from the second user device 12.

Meanwhile, the second type of function suggestion message may include or be composed of text and/or an image inquiring execution of a group of execution functions. For example, the second type of function suggestion message may include a query phrase such as “Do you want to turn on a sports channel on TV?” The second type of function suggestion message may further include a graphic element for identifying the user's intention as either positive or negative, such as “O” and “X” adjacent to the query phrase.

In an embodiment, the first user device 11 may display the second type of function suggestion message on the display based on receiving the second type of function suggestion message. For example, the query phrase included in the second type of function suggestion message may be displayed on the display.

In an embodiment, the first user device 11 may activate the third feedback window for a predetermined time based on receiving a third control command from the intelligent assistant 13. The user input received by the first user device 11 while the third feedback window is activated may be the basis for determining the attribute of the first response to be transmitted to the intelligent assistant 13.

In an embodiment, the first user device 11 may determine the attribute of the first response as either positive feedback or neutral feedback based on not receiving a user input while a predetermined time when the third feedback window is activated elapses.

In an embodiment, the first user device 11 may determine the attribute of the first response as negative feedback based on receiving a user input for changing a group of execution functions for a predetermined time when the second feedback window is activated.

In an embodiment, the intelligent assistant 13 may increase the feedback value of the automation parameter based on receiving the positive feedback and decease the feedback value of the automation parameter based on receiving the negative feedback. Further, the intelligent assistant 13 may maintain and adjust the feedback value of the automation parameter based on the neutral feedback being received (e.g., determine the feedback value as +0.00).

A control method according to an embodiment of the disclosure may be performed by at least one of one or more first user devices 11 (e.g., a wireless terminal device), second user devices 12 (e.g., home appliances), and an intelligent assistant 13 constituting an automation system. More specifically, the control method according to an embodiment may be performed by one or more processors provided in the first and second user devices 11 and 12 and the intelligent assistant 13. In the following disclosure, it may be understood that operations performed by the first user device 11, the second user device 12 and/or the intelligent assistant 13 are supported by the processor provided in each device.

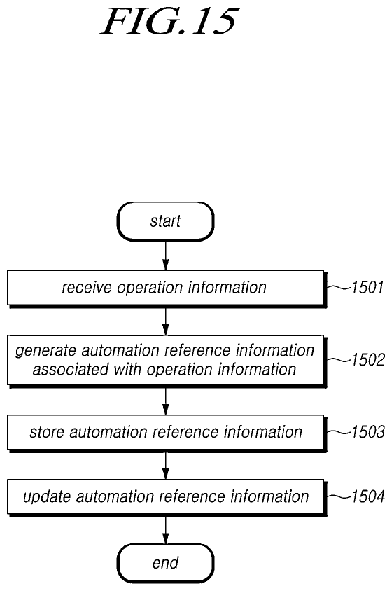

FIG. 15 is a flowchart illustrating a control method according to an embodiment.

Referring to FIG. 15, according to an embodiment, the intelligent assistant may receive operation information (operation 1501). The received operation information may be stored in the memory. The operation information may be received from a first or second user device connected to the intelligent assistant through a network, or may be generated by the intelligent assistant.

In an embodiment, the intelligent assistant may generate automation reference information associated with the operation information (operation 1502). The automation reference information may include the operation information as at least a portion. The automation reference information may include operation information and automation parameters associated with the operation information. The automation parameter may be mapped with the operation information.

In an embodiment, the intelligent assistant may store automation reference information in the memory (operation 1503). The automation reference information stored in the memory may be created into a database.

In an embodiment, the intelligent assistant may update the automation reference information (operation 1504). For example, the intelligent assistant may update the automation parameter mapped with the operation information. Based on the attribute of the response received from the first or second user device, the value of the feedback may be changed. Accordingly, the value of the recommendation degree constituted of the sum of the relevance degree and the feedback may also be changed.

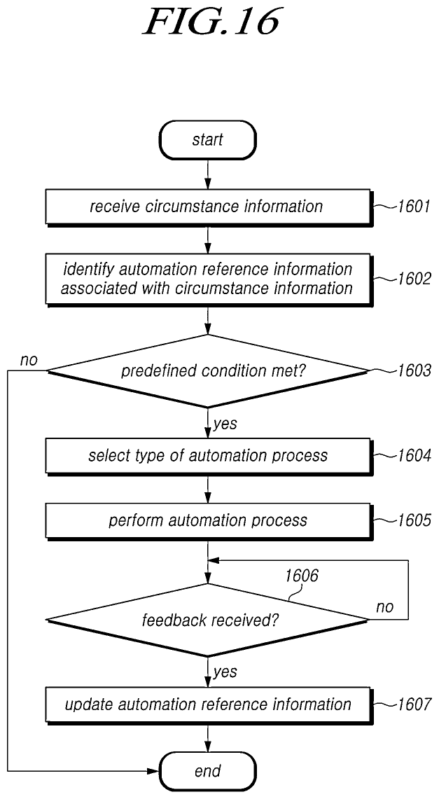

FIG. 16 is a flowchart illustrating a control method according to an embodiment.

Referring to FIG. 16, according to an embodiment, the intelligent assistant may receive circumstance information (operation 1601). The intelligent assistant may receive the circumstance information from the first or second user device wiredly/wirelessly through a network. The intelligent assistant may identify the user's current state by obtaining the circumstance information.

In an embodiment, the intelligent assistant may identify automation reference information associated with the circumstance information (operation 1602). Each of the automation reference information includes the circumstance information as at least a portion. If specific circumstance information is obtained, the intelligent assistant may identify automation reference information that includes the specific circumstance information as at least a portion.

In an embodiment, the intelligent assistant may select at least some of the identified automation reference information based on a predefined condition (operation 1603). The intelligent assistant may select at least some of the plurality of pieces of automation reference information based on the recommendation degree constituting the automation reference information. More specifically, the intelligent assistant may select automation reference information having a recommendation degree equal to or larger than a predefined reference value. This is to exclude automation standard information whose recommendation degree does not meet a certain standard from the execution targets because it is inappropriate for the circumstance information. Here, as the predefined condition, the provided reference value may be defined as the third reference value described above with reference to FIG. 6.

The automation reference information meeting the predefined condition includes the execution function as at least a portion, and may support the second user device of the intelligent assistant to perform the execution function. In other words, the intelligent assistant identifies one or more execution functions that are to be performed by the second user device based on the predefined condition.

In an embodiment, the intelligent assistant may select the type of the automation process based on at least some pieces of automation reference information that meets predefined condition (operation 1603: YES, operation 1604). In an embodiment, the intelligent assistant may identify the type of automation progress for performing the execution function included in the automation reference information, based on the recommendation degree.

In an embodiment, the intelligent assistant may perform the execution function using the determined type of automation process (operation 1605).

In an embodiment, the intelligent assistant may receive feedback from the first user device or the second user device (operation 1606). In the disclosure, the feedback may be configured as at least a portion of the response received from the first or second user device. The feedback may include positive feedback and negative feedback.

In an embodiment, the intelligent assistant may update automation reference information based on attributes of feedback received from the first or second user device (operation 1607). If negative feedback is received, the feedback value associated with the execution function performed due to specific circumstance information may be decreased. If positive feedback is received, the feedback value associated with the execution function performed due to specific circumstance information may increase.

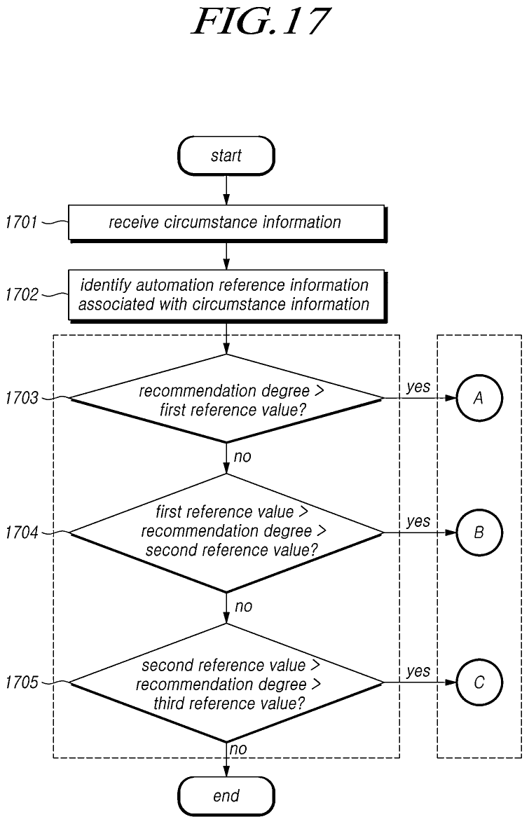

FIGS. 17 to 20 are flowcharts illustrating a control method according to an embodiment.

Operation 1701 and operation 1702 of FIG. 17 are substantially the same as operation 1601 and operation 1602 of FIG. 16, and thus a description thereof will be omitted, and the description will focus primarily on the differences.

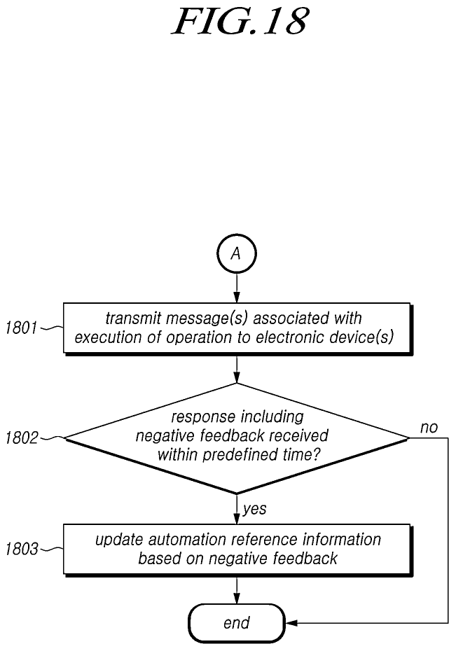

In an embodiment, the intelligent assistant may compare the recommendation degree of the automation reference information with a predefined first reference value (operation 1703). When the recommendation degree is larger than the first reference value, the intelligent assistant performs a subsequent operation A, and the subsequent operation A is described with reference to FIG. 18.

Referring to FIG. 18, the intelligent assistant may transmit a message associated with the execution of an operation (execution function) to an electronic device (e.g., the first or second user device) (operation 1801). Here, the message may include a control command and/or a guide message.

In an embodiment, the intelligent assistant may receive feedback for a predefined time, and may update automation reference information upon receiving a response including negative feedback within the time, or otherwise, does not update the automation reference information (operation 1802: YES, operation 1803)

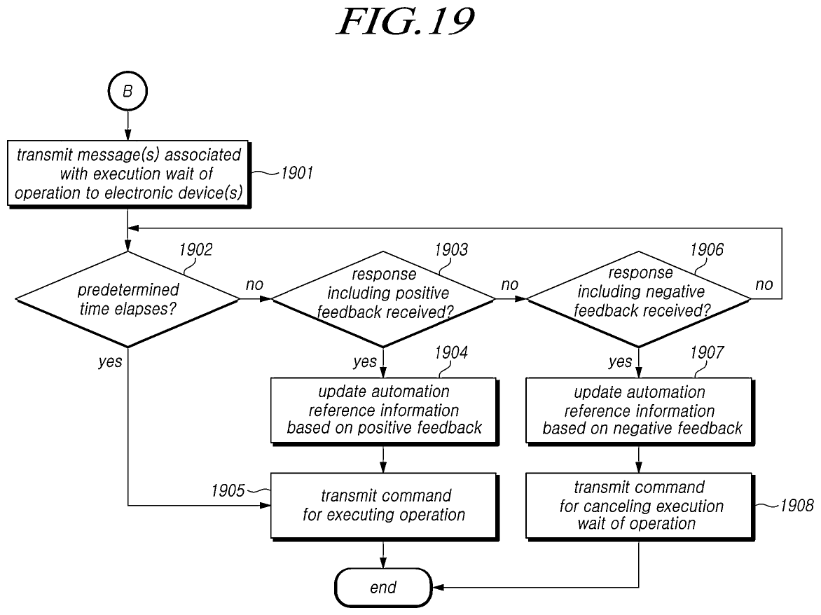

In an embodiment, the intelligent assistant may compare the recommendation degree of automation reference information with predefined first reference value and second reference value (operation 1704). When the recommendation degree is between the first reference value and the second reference value, the intelligent assistant successively performs a subsequent operation B, and the subsequent operation B is described with reference to FIG. 19.

Referring to FIG. 19, the intelligent assistant may transmit a message associated with execution of an operation (execution function) to the electronic device (operation 1901). Here, the message may include a control command and a first type of function suggestion message.

In an embodiment, the intelligent assistant may transmit, to the second user device, a command for executing an execution function to be performed by the automation process if a predefined time elapses (operation 1902: YES, operation 1905).

In an embodiment, if the intelligent assistant receives positive feedback from the first or second user device until the predefined time elapses, the intelligent assistant may update the automation reference information based on the positive feedback (operation 1903: YES, operation 1904). Further, in an embodiment, if the intelligent assistant receives positive feedback from the first or second user device until the predefined time elapses, the intelligent assistant may perform operation 1905. The order of operation 1905 and operation 1904 may be changed, and is not limited to the illustrated embodiments.

In an embodiment, when the intelligent assistant receives negative feedback from the first or second user device until the predefined time elapses, the intelligent assistant may update the automation reference information based on the negative feedback (operation 1906: YES, operation 1907).

In an embodiment, if the intelligent assistant receives negative feedback from the first or second user device until the predefined time elapses, the intelligent assistant may transmit a command for canceling the execution wait of the execution function to the second user device regardless of whether the predefined time elapses (operation 1908). Accordingly, the second user device does not perform the execution function even when the predetermined time elapses.

Meanwhile, in an embodiment, the order of operation 1908 and operation 1907 may be changed, and is not limited to the illustrated embodiments.

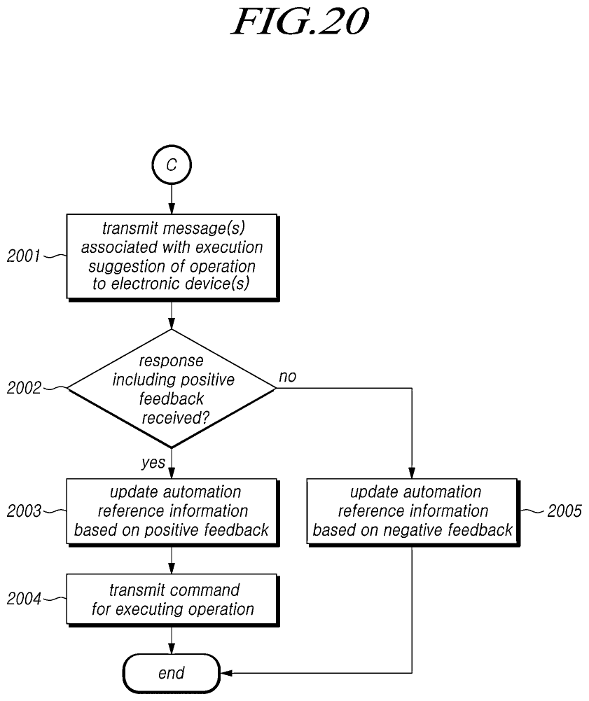

In an embodiment, the intelligent assistant may compare the recommendation degree of automation reference information with a predefined second reference value and a predetermined third reference value (operation 1705). When the recommendation degree is between the second reference value and the third reference value, the intelligent assistant successively performs a subsequent operation C, and the subsequent operation B is described with reference to FIG. 20.

Referring to FIG. 20, the intelligent assistant may transmit a message associated with the execution of an operation (execution function) to the electronic device (operation 2001). Here, the message may include a control command and a second type of function suggestion message.

In an embodiment, upon receiving positive feedback from the first or second user device, the intelligent assistant may update the automation reference information based on the positive feedback (operation 2002: YES, operation 2003). Further, in an embodiment, when the intelligent assistant receives negative feedback from the first or second user device, the intelligent assistant may update the automation reference information based on the negative feedback (operation 2002: NO, operation 2005).

In an embodiment, upon receiving a response including positive feedback, the intelligent assistant may transmit a command to execute an execution function to be performed by the automation process to the second user device (operation 2004).

Meanwhile, in an embodiment, the intelligent assistant may exclude the automation reference information from the targets of the automation process when the recommendation degree of the automation reference information is smaller than the third reference value.

The user devices according to various embodiments of the disclosure may be various types of devices. The user devices may include, for example, a display device, a portable communication device (e.g., a smartphone), a computer device, a portable multimedia device, a portable medical device, a camera, a wearable device, or a home appliance. The user devices according to an embodiment are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in various embodiments of the disclosure, the term “if”' may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the electronic device 10, 11, 12, or 13 described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A method for controlling a user device by an intelligent assistant, the method comprising:
determining an execution function to be performed by the user device and a type of an automation process for performing the execution function based on automation reference information;
transmitting at least one of a control command and a function suggestion message to at least one user device based on the type of the automation process; and
receiving a response to at least one of the control command and the function suggestion message and updating the automation reference information based on an attribute of the received response,
wherein responsive to the type of the automation process being determined as a first type, the control command is defined as a first control command, and the first control command includes one or more instructions controlling the user device to execute the execution function,
wherein responsive to the type of the automation process being determined as a second type, the control command is defined as a second control command, and the second control command includes one or more instructions controlling the user device to execute the execution function in response to an elapse of a predefined time, and
wherein responsive to the type of the automation process being determined as a third type, the control command is defined as a third control command, and the third control command includes one or more instructions controlling the user device to execute the execution function in response to a user input.

2. The method of claim 1, comprising transmitting a guide message to a remote control device connected to the user device through a network based on the type of the automation process being determined as the first type,
wherein the guide message includes text information associated with execution of the execution function.

3. The method of claim 1, comprising:
activating a first feedback window for a predefined time based on the type of the automation process being determined as the first type; and
decreasing a feedback value constituting the automation reference information based on a negative response being received from the user device while the first feedback window is activated.

4. The method of claim 1, comprising transmitting a function suggestion message of the first type together with the second control command to at least one of the user device and a remote control device based on the type of the automation process being determined as the second type,
wherein the function suggestion message of the first type includes text information predicting execution of the execution function.

5. The method of claim 4, comprising
activating a second feedback window for a predefined time based on the type of the automation process being determined as the second type; and
while the second feedback window is activated, increasing a feedback value constituting the automation reference information based on receiving a positive response from any one of the user device and the remote control device, decreasing the feedback value constituting the automation reference information based on receiving a negative response from any one of the user device and the remote control device, and maintaining the feedback value constituting the automation reference information based on receiving a neutral response from any one of the user device and the remote control device.

6. The method of claim 5, comprising transmitting the first control command to enable the user device to perform the execution function based on receiving the positive response from the remote control device.

7. The method of claim 1, comprising transmitting a function suggestion message of the second type together with the third control command to at least one of the user device and a remote control device based on the type of the automation process being determined as the third type,
wherein the function suggestion message of the second type includes a query for execution of the execution function.

8. The method of claim 7, comprising:
activating a third feedback window for a predefined time based on the type of the automation process being determined as the third type; and
while the third feedback window is activated, increasing a feedback value constituting the automation reference information based on receiving a positive response from any one of the user device and the remote control device, and decreasing the feedback value constituting the automation reference information based on receiving a negative response from any one of the user device and the remote control device.

9. The method of claim 7, comprising transmitting the first control command to enable the user device to perform the execution function based on receiving the positive response from the remote control device.

10. The method of claim 7, wherein the third control command includes one or more instructions controlling the user device to output text information constituting the function suggestion message of the second type as a voice.

11. The method of claim 10, comprising determining a speech pattern of the voice output based on the automation reference information,
wherein the speech pattern includes at least one of a frequency, a pitch, an utterance time, an utterance speed, an inter-phrase time width, or an inter-word time width.

12. The method of claim 11, wherein as a recommendation degree of the automation reference information decreases, at least one of the inter-phrase time width or the inter-word time width increases.

13. The method of claim 11, wherein as a recommendation degree of the automation reference information increases, the speech pattern is composed of a downward intonation.

14. The method of claim 11, wherein as a recommendation degree of the automation reference information decreases, the speech pattern is composed of an upward intonation.

15. An intelligent assistant, comprising:
a transceiver;
a processor connected electrically to the transceiver; and
a memory connected electrically to the processor and configured to store instructions executable by the processor, wherein the instructions, when executed by the processor, cause the intelligent assistant to:
determine an execution function to be performed by a user device and a type of an automation process for performing the execution function based on automation reference information;
transmit at least one of a control command and a function suggestion message to at least one user device based on the type of the automation process; and
receive a response to at least one of the control command and the function suggestion message and updating the automation reference information based on an attribute of the received response,
wherein responsive to the type of the automation process being determined as a first type, the control command is defined as a first control command, and the first control command includes one or more instructions controlling the user device to execute the execution function,
wherein responsive to the type of the automation process being determined as a second type, the control command is defined as a second control command, and the second control command includes one or more instructions controlling the user device to execute the execution function in response to an elapse of a predefined time, and
wherein responsive to the type of the automation process being determined as a third type, the control command is defined as a third control command, and the third control command includes one or more instructions controlling the user device to execute the execution function in response to a user input.

16. The intelligent assistant of claim 15, wherein the instructions are configured to, when executed by the processor, cause the intelligent assistant to:
transmit a guide message to a remote control device connected to the user device through a network based on the type of the automation process being determined as the first type,
wherein the guide message includes text information associated with execution of the execution function.

17. The intelligent assistant of claim 15, wherein the instructions are configured to, when executed by the processor, cause the intelligent assistant to:
activate a first feedback window for a predefined time based on the type of the automation process being determined as the first type; and
decrease a feedback value constituting the automation reference information based on a negative response being received from the user device while the first feedback window is activated.

18. The intelligent assistant of claim 15, wherein the instructions are configured to, when executed by the processor, cause the intelligent assistant to:
transmit a function suggestion message of the first type together with the second control command to at least one of the user device and a remote control device based on the type of the automation process being determined as the second type,
wherein the function suggestion message of the first type includes text information predicting execution of the execution function.

19. The intelligent assistant of claim 18, wherein the instructions are configured to, when executed by the processor, cause the intelligent assistant to:
activate a second feedback window for a predefined time based on the type of the automation process being determined as the second type; and
while the second feedback window is activated, increase a feedback value constituting the automation reference information based on receiving a positive response from any one of the user device and the remote control device, decrease the feedback value constituting the automation reference information based on receive a negative response from any one of the user device and the remote control device, and maintain the feedback value constituting the automation reference information based on receiving a neutral response from any one of the user device and the remote control device.

20. The intelligent assistant of claim 19, wherein the instructions are configured to, when executed by the processor, cause the intelligent assistant to transmit the first control command to enable the user device to perform the execution function based on receiving the positive response from the remote control device.
